(19) United States
(12) Patent Application Publication
(10) Pub. No.: US 2009/0253821 A1
(43) Pub. Date: Oct. 8, 2009

(54) Polyurethane foam with water absorbency and yellowing resistance

(75) Inventors: Satoshi Iwase, Anjo-shi (JP); Tadashi Yano, Anjo-shi (JP); Nobuyuki Makihara, Anjo-shi (JP)

Correspondence Address: CROMPTON, SEAGER & TUFTE, LLC, 1221 NICOLLET AVENUE, SUITE 800, MINNEAPOLIS, MN, 55403-2420, US

(73) Assignee: INOAC CORPORATION, Nagoya-shi (JP)

(21) Appl. No.: 12/098,530

(22) Filed: Apr. 7, 2008

(51) Int. Cl. C08G 18/32

(52) U.S. Cl. 521/173; 521/155

(57) ABSTRACT

A polyurethane foam is obtained by reacting raw materials containing a polyisocyanate, a polyol, a water-absorbency-imparting agent, a catalyst, and a blowing agent, foaming the reaction mixture, and curing the foamed product. The polyol is a polyester polyol. The water-absorbency-imparting agent is a polyoxyalkylene compound having a molecular weight of 100 to 1000 and having a hydroxy group at an end of the molecular chain, or an alcohol with 1 to 8 carbon atoms. The amount of the water-absorbency-imparting agent is from 0.5 to 8 parts by mass per 100 parts by mass of the polyester polyol. The polyisocyanate is an aliphatic polyisocyanate, an alicyclic polyisocyanate, or an aromatic polyisocyanate in which the isocyanate groups are not directly attached to an aromatic ring. The foam has a water absorption ratio of 10 to 30 and a color difference ΔYI of 7 or less. The time required until water dropped onto a surface of the foam is completely absorbed into the foam is 20 seconds or less.

### BACKGROUND OF THE INVENTION

The present invention relates to a polyurethane foam for use as, for example, gauzes, which foam has water absorbency and yellowing resistance, and exhibits good water absorbency while being resistant to yellowing even when exposed to light, etc.

Gauzes have conventionally found a variety of uses because of their excellent water absorbency and moisturizing properties, such as, in addition to uses in surgical treatments, uses as underwear, handkerchiefs, towels, masks, filtration materials, sheets, and the like. However, gauzes are fibrous and therefore tend to ravel. In particular, when used in surgical treatments, gauzes cannot easily be removed by the fibers adhering to wounds. For this reason, the use of polyurethane foam is considered due to its breathability, water absorbency, and moisturizing properties.

Japanese Laid-Open Patent Publication No. 2005-187788 discloses a polyurethane foam with water absorbency and moisturizing properties. The water-absorbing polyurethane foam is produced by reacting a polyol with a polyisocyanate compound in the presence of a catalyst, a blowing agent, and a foam stabilizer. The polyol is a polyester polyol, and compounds containing hydroxy groups are further added to the raw materials. Although the resulting polyurethane foam exhibits good water absorbency, it turns yellowish (yellowing) due to a polyisocyanate compound such as, in particular, tolylenediisocyanate (TDI).

Japanese Laid-Open Patent Publication No. 2001-72738 proposes a polyurethane foam with reduced yellowing. The polyurethane foam is produced by reacting an aliphatic polyisocyanate with a polyol component in the presence of a catalyst, followed by curing the reaction mixture. The polyurethane foam is resistant to yellowing because an aliphatic polyisocyanate is used as a polyisocyanate compound.

For use as gauzes, water absorbency is of course demanded in a polyurethane foam, but yellowing of the foam also needs to be reduced because it gives users an unsanitary feeling, or an impression of deterioration. As explained above, the polyurethane foam described in Japanese Laid-Open Patent Publication No. 2001-72738 exhibits reduced yellowing because of use of an aliphatic polyisocyanate as a polyisocyanate compound. However, a polyoxyalkylene polyol such as polyoxypropylene triol is used as a polyol component. Although this reduces the swelling ratio of the polyurethane foam in water, and enhances the water resistance and durability, the polyurethane foam has an insufficient water absorbency. Accordingly, a polyurethane foam that exhibits both water absorbency and yellowing resistance has not been obtained; therefore, there is a demand for a polyurethane foam that satisfies both of these properties.

### SUMMARY OF THE INVENTION

The objective of the present invention is to provide a polyurethane foam that satisfies both water absorbency and yellowing resistance.

To achieve the foregoing objective and in accordance with one aspect of the present invention, a polyurethane foam with water absorbency and yellowing resistance is provided. The polyurethane foam has a water absorption ratio of 10 to 30 and a color difference ΔYI of 7 or less. The water absorption ratio is expressed by Equation (1):

water absorption ratio=(mass after water absorption−mass before water absorption)/mass before water absorption (1).

The “mass after water absorption” is the mass of the polyurethane foam measured after immersing the polyurethane foam in water at ordinary temperature (25° C.) for 3 minutes, and then leaving it on a wire gauze for 1 minute. The color difference ΔYI is expressed by Equation (2):

ΔYI=YI−YI₀ (2).

YI is a value that indicates a degree of yellowing of the polyurethane foam as measured by a color difference meter after leaving the polyurethane foam for 24 hours in a desiccator charged with 50 ppm nitrogen dioxide, and then removing the polyurethane foam from the desiccator. YI₀ is a value of YI of the polyurethane foam before being placed in the desiccator.

### DETAILED DESCRIPTION OF THE PREFERRED EMBODIMENTS

One embodiment of the present invention is described in detail below. A polyurethane foam with water absorbency and yellowing resistance according to the embodiment has a water absorption ratio of 10 to 30 as expressed by Equation (1) shown below and a color difference ΔYI of 7 or less as expressed by Equation (2) shown below. That is to say, the water absorbency of the polyurethane foam is expressed by the water absorption ratio, and the yellowing resistance of the polyurethane foam is expressed by the color difference ΔYI. The polyurethane foam with water absorbency and yellowing resistance will hereinafter simply be referred to as the “polyurethane foam”.

Water absorption ratio=(mass after water absorption−mass before water absorption)/mass before water absorption (1),

wherein the “mass after water absorption” is the mass of the polyurethane foam measured after immersing the polyurethane foam in water at ordinary temperature (25° C.) for 3 minutes, and then leaving it on a wire gauze for 1 minute. The wire gauze is used to remove water adhering to the polyurethane foam therefrom, and may be any that has a coarse mesh (for example, 5×5 mm).

ΔYI=YI−YI₀ (2),

wherein YI is a value that indicates a degree of yellowing of the polyurethane foam as measured by a color difference meter after leaving the polyurethane foam for 24 hours in a desiccator charged with 50 ppm nitrogen dioxide, and then removing the polyurethane foam from the desiccator; and YI₀ is a value of YI of the polyurethane foam before being placed in the desiccator.

Polyurethane foams, in general, have a water absorption ratio of less than 10; however, the polyurethane foam according to the embodiment has a water absorption ratio as high as 10 to 30. When the water absorption ratio is less than 10, the polyurethane foam has low water absorbency, and cannot be put to uses that require water absorbency such as gauzes. If the water absorption ratio of a foam exceeds 30, it will be difficult to produce the foam because the equilibrium of reaction mixture during foaming shift unfavorable manner, resulting in, for example, defective foaming.

The polyurethane foam with a color difference ΔYI of 7 or less has no yellowing problems, and therefore can be used as a yellowing-resistant polyurethane foam. A color difference ΔYI in excess of 7 is not suitable because the degree of yellowing will significantly increase, and the use of such a polyurethane foam as gauzes or the like will give users an unsanitary feeling or an impression of deterioration.

Preferably, the polyurethane foam is obtained by reacting raw materials containing a polyisocyanate, a polyol, a water-absorbency-imparting agent, a catalyst, and a blowing agent, foaming the reaction mixture, and curing the foamed product. In this case, the polyol is a polyester polyol in order to express water absorbency. Also, the water-absorbency-imparting agent is a polyoxyalkylene compound having a molecular weight of 100 to 1000 and having a hydroxy group at an end of the molecular chain, or an alcohol with 1 to 8 carbon atoms. The amount of the water-absorbency-imparting agent is set to 0.5 to 8 parts by mass per 100 parts by mass of the polyester polyol. In order to express yellowing resistance, the polyisocyanate is an aliphatic polyisocyanate, an alicyclic polyisocyanate, or an aromatic polyisocyanate in which the isocyanate groups are not directly attached to an aromatic ring.

The raw materials of the polyurethane foam will now be described in order. A polyester polyol is used as the polyol because it has low compatibility with the water-absorbency-imparting agent, allowing the cells to be broken and open, and allowing the water-absorbency-imparting agent to bleed onto the surface of the polyurethane foam to thereby enhance the hydrophilic properties of the foam. Examples of polyester polyols include condensed polyester polyols obtained by reacting polycarboxylic acids with polyols, lactone polyester polyols, polycarbonate polyols, and modified polyester polyols thereof. One of these specific examples may be used singly, or two or more of them may be used in combination. Examples of polycarboxylic acids include adipic acid, phthalic acid, and sebacic acid. Examples of polyols include ethylene glycol, diethylene glycol, propylene glycol, glycerol, hexanetriol, and trimethylolpropane.

A diethylene glycol adipate ester polyol with an average hydroxy functionality of 2 to 3 is preferable as the polyester polyol, in order to suppress swelling of the polyurethane foam when water is absorbed to thereby increase the strength of the foam. The diethylene glycol adipate ester polyol preferably has a number average molecular weight of 1000 to 4000. The number average molecular weight will hereinafter simply be referred to as the “molecular weight”. If the molecular weight is less than 1000, the resulting polyurethane foam tends to be rigid, and the flexibility of the foam will easily be impaired. If the molecular weight exceeds 4000, the polyurethane foam tends to have poor rigidity and strength. If the average hydroxy functionality is less than 2, the polyurethane foam may not be sufficiently crosslinked, resulting in a reduction in the shape retainability of the foam. If the average hydroxy functionality exceeds 3, the polyurethane foam tends to be too tightly crosslinked, making the foam excessively rigid.

The polyester polyol has a hydroxy value of preferably from 20 to 200 mg KOH/g, and more preferably from 40 to 80 mg KOH/g. If the polyester polyol has a hydroxy value of less than 20 mg KOH/g, the hydroxy value is excessively low, which may reduce the crosslink density of the polyurethane foam, resulting in a reduction in the shape retainability of the foam. If the polyester polyol has a hydroxy value in excess of 200 mg KOH/g, the hydroxy value is excessively high, which may increase the crosslink density of the polyurethane foam, resulting in a tendency for the foam to be rigid and a closed-cell foam, in which the cells have closed cell structure. When the polyester polyol has a hydroxy value of 40 to 80 mg KOH/g, the crosslink density of the polyurethane foam is in a proper range, resulting in good mechanical properties of the foam. The hydroxy functionality and hydroxy value of the polyester polyol can be changed by adjusting the type of the raw material components, molecular weight, degree of condensation, and the like of the polyester polyol.

Polyoxyalkylene compounds having a molecular weight of 100 to 1000 and having a hydroxy group at an end of the molecular chain or alcohols with 1 to 8 carbon atoms as the water-absorbency-imparting agent are explained next. These compounds allow the cells of the polyurethane to be open, and impart hydrophilic properties to the surface of the foam. These compounds have low compatibility with the polyester polyol, and are considered to break the cell membranes to form an open cell structure, and bleed onto the surface of the foam to impart hydrophilic properties to the polyurethane foam. Examples of polyoxyalkylene compounds include polyethylene glycols or modified compounds thereof, and polyoxyethylene alkylethers. Examples of polyethylene glycols include polyethylene oxide. The polyethylene glycols or modified compounds thereof contain one, two, or three hydroxy groups per molecule. The polyoxyethylene alkylethers contain one hydroxy group per molecule. One of these specific examples may be used singly, or two or more of them may be used in combination.

The water-absorbency-imparting agent preferably comprises any of the aforementioned polyoxyalkylene compounds as a main component. The use of a polyoxypropylene compound or the like alone is not preferable because such compounds fail to provide sufficient hydrophilic properties. The polyoxyalkylene compound has a molecular weight of 100 to 1000, and preferably 200 to 1000. If the polyoxyalkylene compound has a molecular weight of less than 100, the stability during foaming will decrease to cause the foam to collapse. If the polyoxyalkylene compound has a molecular weight in excess of 1000, the balance of the raw materials will decrease to cause defective foaming.

Examples of alcohols with 1 to 8 carbon atoms include monohydric alcohols, dihydric alcohols, trihydric alcohols, and polyhydric alcohols. Examples of monohydric alcohols include methanol, ethanol, propanol, isopropanol, butanol, and octanol. Examples of dihydric alcohols include ethylene glycol, diethylene glycol, propylene glycol, and dipropylene glycol. Examples of trihydric alcohols include glycerol and trimethylolpropane. Examples of polyhydric alcohols include pentaerythritol. One of these specific examples may be used singly, or two or more of them may be used in combination. The alcohol preferably has 2 to 5 carbon atoms in view of, for example, the balance between the hydrophilic properties and reactivity.

The amount of the water-absorbency-imparting agent is from 0.5 to 8 parts by mass, and preferably 1 to 6 parts by mass, based on 100 parts by mass of the polyester polyol, in order to sufficiently fulfill the above-described function.

If the amount of the water-absorbency-imparting agent is less than 0.5 parts by mass, the function of the water-absorbency-imparting agent to make the cells open and impart hydrophilic properties cannot be sufficiently obtained, resulting in poor water absorbency of the polyurethane foam. If the amount of the water-absorbency-imparting agent exceeds 8 parts by mass, the excessive amount of the water-absorbency-imparting agent will render the formulation of the raw materials poor, resulting in defective foaming.

An aliphatic polyisocyanate, an alicyclic polyisocyanate, or an aromatic polyisocyanate in which the isocyanate groups are not directly attached to an aromatic ring is used as the polyisocyanate. In the case of an aromatic polyisocyanate in which the isocyanate groups are directly attached to an aromatic ring, the aromatic ring is converted to a quinoid due to light such as solar light to form a coloring component (a quinone compound). Therefore, in the embodiment, polyisocyanates that do not form such coloring components are used. Aromatic rings include condensed benzene rings such as naphthalene, as well as benzene rings.

Examples of aliphatic polyisocyanates include hexamethylene diisocyanate (HDI), lysine diisocyanate (LDI), butene diisocyanate (BDI), 1,3-butadiene-1,4-diisocyanate, octamethylene diisocyanate, lysine ester triisocyanate, 1,8-diisocyanate-4-isocyanatemethyloctane, 1,6,11-undecane triisocyanate, 1,3,6-hexamethylene triisocyanate, and modified polyisocyanates thereof. One of these specific examples may be used singly, or two or more of them may be used in combination.

Examples of alicyclic polyisocyanates include isophorone diisocyanate (IPDI), hydrogenated xylenediisocyanate (hydrogenated XDI), hydrogenated diphenylmethane diisocyanate (hydrogenated MDI), cyclohexyl diisocyanate (CHDI), methylcyclohexyl diisocyanate, dicyclohexylmethane diisocyanate, bicycloheptane triisocyanate, and modified polyisocyanates thereof. One of these specific examples may be used singly, or two or more of them may be used in combination.

Examples of aromatic polyisocyanates in which the isocyanate groups are not directly attached to an aromatic ring include xylenediisocyanate (XDI), tetramethyl xylenediisocyanate (TMXDI), and modified polyisocyanates thereof. One of these specific examples may be used singly, or two or more of them may be used in combination.

Examples of the aforementioned modified polyisocyanates include urethane-modified polyisocyanates, dimers, trimers, carbodiimide-, allophanate-, biuret-, and urea-modified polyisocyanates, and prepolymers. Among these polyisocyanates, alphatic or alicyclic polyisocyanates are preferred because they impart excellent yellowing resistance to the polyurethane foam.

The polyisocyanate preferably has an isocyanate index of 80 to 120, and more preferably 100 to 120. The isocyanate index represents the equivalent ratio in percentage of the isocyanate groups of the polyisocyanate relative to the total amount of the hydroxy groups of the polyester polyol, the hydroxy groups of the water-absorbency-imparting agent, and the active hydrogen groups of the blowing agent such as water. If the isocyanate index is less than 100, there will be more active hydrogen groups than isocyanate groups. If the isocyanate index exceeds 100, there will be more isocyanate groups than active hydrogen groups. If the isocyanate index is less than 80, the polyester polyol cannot sufficiently react with the polyisocyanate, which prevents resinification from proceeding, possibly making the polyurethane foam sticky, or reducing the physical properties, such as the strength, of the foam. If the isocyanate index exceeds 120, there will be excess isocyanate groups, making the polyurethane foam excessively rigid, accompanied by the difficulty in obtaining a flexible foam.

A catalyst promotes, for example, the urethanization reaction between the polyol and the polyisocyanate and the foaming reaction between the polyisocyanate and water as a blowing agent. Examples of catalysts include diazabicycloalkenes with amidino groups [H₂NC(═NH)—] and salts thereof, tertiary amines, guanidine derivatives, and weakly acid alkali metal salts. Examples of diazabicycloalkenes with amidino groups [H₂NC(═NH)—] include 1,8-diazabicyclo(5.4.0)undecene-7 and 1,5-diazabicyclo(4.3.0)nonene-5. Examples of tertiary amines include N,N′,N′-trimethylaminoethylpiperazine, triethylenediamine, and dimethylethanolamine. One of these specific examples may be used singly, or two or more of them may be used in combination. Among these specific examples, diazabicycloalkenes and salts thereof are preferred because of their high catalytic activity.

A blowing agent forms foam by allowing the raw materials of the polyurethane foam to foam. Examples of blowing agents include water, pentane, cyclopentane, hexane, cyclohexane, dichloromethane, methylene chloride, and carbon dioxide gas. One of these specific examples may be used singly, or two or more of them may be used in combination. Of these specific examples, water is preferably used because of its good reactivity during the foaming reaction and ease of handling.

Raw materials of the polyurethane foam preferably contain a foam stabilizer. A foam stabilizer adjusts the size and homogeneity of the cells of the polyurethane foam. In order to prevent the foam from collapsing, a water-soluble compound is used as a foam stabilizer. A silicone compound is preferable as a water-soluble foam stabilizer. A silicone compound exhibits an excellent surface-activation effect, enhances the compatibility among the components of the raw materials of the polyurethane foam, and is capable of stabilizing the foam to produce a fine, homogeneous foam. Examples of silicone compounds that act as non-ionic surfactants include organosiloxane-polyoxyalkylene copolymers, silicone-grease copolymers, and mixtures thereof. The amount of the foam stabilizer is preferably about 0.5 to about 6 parts by mass per 100 parts by mass of the polyol.

In addition to the aforementioned components, a cell opener, a flame retardant such as a condensed phosphoric ester, an antioxidant, a plasticizer, an ultraviolet absorber, a coloring agent, and the like may also be used as raw materials of the polyurethane foam.

A one-shot process that directly induces reactions in one step is employed to react the polyol and the polyisocyanate. Although the reactions in that case are complicated, the process basically involves the following predominant reactions: the addition polymerization reaction of the polyol and the polyisocyanate (the urethanization reaction or resinification reaction); the foaming reaction of the polyisocyanate and the blowing agent; and the crosslinking reaction (the curing reaction) of the resulting reaction product and the polyisocyanate.

The thus-obtained polyurethane foam is a flexible foam with an open cell structure, in which the cells are open, and thus has water absorbency. In the case of a closed cell polyurethane foam, the closed cells inhibit water from entering the cells, making it impossible for the foam to have water absorbency. In order to achieve an open cell structure, it is preferable that, at the foaming stage, the time during which the raw materials are present in the form of a cream (the cream time) be set to about 10 to about 60 seconds. Subsequent to the formation of cells, the time measured from when the raw materials are poured to when foaming proceeds the furthest to reach the maximum foam height (the rise time) be set to about 1 to about 5 minutes.

The polyurethane foam according to the embodiment is produced by a known polyurethane foam producing apparatus. For example, the polyurethane foam is obtained by cutting a known polyurethane slabstock foam. A polyurethane slabstock foam is obtained by the following steps. Two liquid raw materials mainly comprising a polyol and a polyisocyanate are supplied into the chamber of an injection device (a high-pressure injection device), in which the two liquids are mixed and agitated. The agitated raw material mixture is then discharged onto a conveyor belt, and the raw material mixture (reaction mixture) is allowed to foam on the moving conveyor at ordinary temperature (25° C.) and at atmospheric pressure (0.1 MPa), followed by curing the foam in a dry oven. The resulting polyurethane slabstock foam is cut to a predetermined length and then sliced, and the sliced foam is die cut or cut to a predetermined shape, thus giving a polyurethane foam of a desired shape. The polyurethane foam can also be produced by methods such as molding, on-site spraying, etc. Owing to its open cell structure and surface characteristics, the resulting polyurethane foam exhibits sufficient water absorbency.

The thus-obtained polyurethane foam has a water absorption ratio of 10 to 30 as expressed by Equation (1) above, and requires a period of 20 seconds or less until water is completely absorbed therein; therefore, the foam exhibits excellent water absorbency. The water absorbency is represented by the water absorption ratio and the water absorption period (water absorption rate). Moreover, the polyurethane foam has a color difference ΔYI of 7 or less as expressed by Equation (2) above, and therefore exhibits excellent yellowing resistance. In addition, the polyurethane foam has, for example, an apparent density of 30 to 40 kg/m³ based on JIS K 7222 of the Japanese Industrial Standards (ISO 845 of the International Standards); a rigidity of 70 to 90 N based on JIS K 6400-2 (ISO 2439); a tensile strength of 90 to 130 kPa based on JIS K 6400-5 (ISO 1798); and an elongation of 220 to 260% based on JIS K 6400-5 (ISO 1798).

The polyurethane foam has a water absorption ratio of 10 to 30 as expressed by Equation (1) above, and exhibits high water absorbency. The reason for this can be explained as follows. The polyoxyalkylene compound or alcohol as a water-absorbency-imparting agent has low compatibility with the polyester polyol. Therefore, the membranes of the cells formed via the foaming reaction are broken and thus made open to form an open cell structure, and the water-absorbency-imparting agent bleeds onto the surface of the foam to impart hydrophilic properties to the foam. Moreover, since the molecular weight and the amount of the water-absorbency-imparting agent used are suitable, the polyurethane foam has sufficient water absorbency. Hence, water that has entered into the polyurethane foam is absorbed by rapidly passing through the cells.

The polyurethane foam has a color difference ΔYI of 7 or less as expressed by Equation (2) above, and exhibits sufficient yellowing resistance. The reason for this can be explained as follows. In the case of a polyisocyanate in which the isocyanate groups are directly attached to an aromatic ring, the aromatic ring is converted into a quinoid due to light to form a coloring component such as a quinone compound. In contrast, with an aliphatic polyisocyanate, an alicyclic polyisocyanate, or an aromatic polyisocyanate in which the isocyanate groups are not directly attached to an aromatic ring, the formation of such a coloring component is avoided.

The above-described embodiment provides advantages as follows.

In the polyurethane foam of the embodiment, the water absorption ratio expressed by Equation (1) above is set to 10 to 30, and the color difference ΔYI expressed by Equation (2) above is set to 7 or less. Therefore, the polyurethane foam has a high water absorption ratio and a low color difference of yellowing, and hence exhibits sufficient water absorbency (water retention properties) and sufficient yellowing resistance.

Preferably, the polyurethane foam of the embodiment is obtained by reacting raw materials containing a polyisocyanate, a polyol, a water-absorbency-imparting agent, a catalyst, and a blowing agent, foaming the reaction mixture, and curing the foamed product. In this case, the use of a polyester polyol as the polyol makes the cells open, and allows the water-absorbency-imparting agent to bleed onto the surface of the foam to thereby impart hydrophilic properties to the foam. The water-absorbency-imparting agent is any of the above-mentioned polyoxyalkylene compounds or alcohols, and the amount of the water-absorbency-imparting agent is from 0.5 to 8 parts by mass per 100 parts by mass of the polyol. Since the molecular weight and the amount of the water-absorbency-imparting agent used are thus suitable, the resulting polyurethane foam has hydrophilic properties, and exhibits good foaming properties. In addition, the use of an aliphatic polyisocyanate, an alicyclic polyisocyanate, or an aromatic polyisocyanate in which the isocyanate groups are not directly attached to an aromatic ring as the polyisocyanate results in reduced yellowing of the polyurethane foam.

Furthermore, the use of a diazabicycloalkene or a salt thereof as a catalyst enhances the catalytic activity to promote reactions such as the urethanization reaction, crosslinking reaction, and the like.

Preferably, the time required for water dropped onto the surface of the polyurethane foam is completely absorbed in the polyurethane foam is set to 20 seconds or less. This structure increases the water absorption rate of the polyurethane foam.

It should be apparent to those skilled in the art that the present invention may be embodied in many other specific forms without departing from the spirit or scope of the invention. Particularly, it should be understood that the invention may be embodied in the following forms.

A compound with a hydrophilic group such as amide may also be used as the water-absorbency-imparting agent.

A combination of, for example, an aliphatic polyisocyanate and an alicyclic polyisocyanate may also be used as the polyisocyanate.

As a method for producing a polyurethane foam with water absorbency and yellowing resistance, a method may be employed which comprises supplying raw materials of the polyurethane foam onto a mold-release film; producing a polyurethane foam by reacting the raw materials, foaming the reaction mixture, and curing the foamed product; and removing the foam from the mold-release film.

The above-described embodiment will hereinafter be described in greater detail with reference to Examples and Comparative Examples; however, the present invention is not limited by these Examples.

### Examples 1 to 11 and Comparative Examples 1 to 6

Compounds shown in Tables 1 to 3 were prepared as raw materials of polyurethane foams, and polyurethane foams were produced employing a known method and apparatus for producing polyurethane slabstock foams. The abbreviations used in Tables 1 to 3 are explained below. In Tables 1 to 3, the numerical values for the compounds contained in the raw materials listed in the columns are expressed in parts by mass. The resulting polyurethane foams were measured for their apparent densities (kg/m³), rigidities (N), tensile strengths (kPa), elongations (%), water absorption periods (second), water absorption ratios (ratio), and color differences (ΔYI), according to the methods explained below. The results are shown in Tables 1 to 3.

N2200: a diethylene glycol adipate polyester polyol manufactured by Nippon Polyurethane Industry, Co., Ltd., having an average hydroxy functionality of 2, a molecular weight of 3000, and a hydroxy value of 60.5 mg KOH/g;

GP3050F: a polyether polyol manufactured by Sanyo Chemical Industries, Ltd., a triol obtained by the addition polymerization of glycerol with propylene oxide, having a molecular weight of 3000 and a hydroxy value of 56 mg KOH/g;

PEG600: a polyethylene glycol (a polyethylene oxide) manufactured by Sanyo Chemical Industries, Ltd., having two hydroxy groups per molecule, a molecular weight of 600, and a hydroxy value of 187 mg KOH/g;

GE1000: a polyether polyol obtained by adding ethylene oxide to glycerol, manufactured by Lion Corporation, having three hydroxy groups per molecule, a molecular weight of 1000, and a hydroxy value of 168 mg KOH/g;

PEG200: a polyethylene glycol (a polyethylene oxide) manufactured by Sanyo Chemical Industries, Ltd., having two hydroxy groups per molecule, a molecular weight of 200, and a hydroxy value of 561 mg KOH/g;

PEG1540: a polyethylene glycol (a polyethylene oxide) manufactured by Sanyo Chemical Industries, Ltd., having two hydroxy groups per molecule, a molecular weight of 1540, and a hydroxy value of 73 mg KOH/g;

GP-600: a polyethylene oxide adduct triol manufactured by Adeka Corporation, having three hydroxy groups per molecule, a molecular weight of 600, and a hydroxy value of 187 mg KOH/g;

IPDI: an isophorone diisocyanate;

T-65: a tolylene diisocyanate manufactured by Nippon Polyurethane Industry, Co., Ltd., a mixture of 65% by mass of 2,4-tolylene diisocyanate and 35% by mass of 2,6-tolylene diisocyanate;

Foam stabilizer: silicone SZ1649 manufactured by Dow Corning Toray Co., Ltd.;

Catalyst 1: DBU, 1,8-diazabicyclo(5,4,0)undecene-7, manufactured by San Apro Ltd.;

Catalyst 2: DBN, 1,5-diazabicyclo(4,3,0)nonene-5, manufactured by San Apro Ltd.;

Catalyst 3: dimethylethanolamine; and

Catalyst 4: KS1260, dibutyltin dilaurate, manufactured by Kyodo Chemical Co, Ltd.

### (Measurement Method)

Apparent density (kg/m³): the apparent densities of the polyurethane foams of the Examples and Comparative Examples were measured in accordance with the method specified in JIS K 7222; 1999 (ISO 845). In Tables 1 to 3, apparent density will hereinafter simply be referred to as the “density.”

Rigidity (N): the rigidities of the polyurethane foams of the Examples and Comparative Examples were measured in accordance with the method specified in JIS K 6400-2; 2004 (ISO 2439).

Tensile strength (kPa): the tensile strengths of the polyurethane foams of the Examples and Comparative Examples were measured in accordance with the method specified in JIS K 6400-5; 2004 (ISO 1798).

Elongation (%): the elongations of the polyurethane foams of the Examples and Comparative Examples were measured in accordance with the method specified in JIS K 6400-5; 2004 (ISO 1798).

Water absorption period (second): 0.5 ml of water was dropped with a syringe onto the surface of a 50-mm-long, 50-mm-wide, and 10-mm-thick piece of each of the polyurethane foams of the Examples and Comparative Examples, and the period (second) required for the water to be completely absorbed in the foam was measured with a stopwatch.

Water absorption ratio (ratio): each of the polyurethane foams of Examples and Comparative Examples was immersed in water at ordinary temperature (25° C.) for 3 minutes and then removed from the water. The foam was subsequently left on a wire gauze with 5×5 mm meshes for 1 minute. The mass of the polyurethane foam was then measured, and the water absorption ratio was calculated according to Equation (1) above.

Color difference (ΔYI): a sample of each of the polyurethane foams of the Examples and Comparative Examples was placed in a desiccator, and the desiccator was charged with 50 ppm nitrogen dioxide (NO₂) gas while measuring the concentration of nitrogen dioxide with a detector tube. The sample was left in that state for 24 hours. The sample was then removed from the desiccator, and the degree of yellowing was measured using a color difference meter (“SM Color Computer SM-4” by manufactured by Suga Test Instruments, Co., Ltd.). The color difference (ΔYI) was calculated according to Equation (2) above. If the color difference (ΔYI) is 7 or less, yellowing of the polyurethane foam will practically not be problematic.

TABLE 1

| | Ex. 1 | Ex. 2 | Ex. 3 | Ex. 4 | Ex. 5 |
|---|---|---|---|---|---|
| N2200 | 100 | 100 | 100 | 100 | 100 |
| PEG600 | 3.0 | 1.5 | 6.0 | — | — |
| GE1000 | — | — | — | 3.0 | — |
| PEG200 | — | — | — | — | 3.0 |
| Water | 2.6 | 2.6 | 2.6 | 2.6 | 2.6 |
| Foam stabilizer | 1.5 | 1.5 | 1.5 | 1.5 | 1.5 |
| Catalyst 1 | 1.0 | 1.0 | 1.0 | 1.0 | 1.0 |
| IPDI | 56.9 | 56.3 | 58.1 | 56.8 | 59.3 |
| Isocyanate index | 110 | 110 | 110 | 110 | 110 |
| Density (kg/m³) | 34.7 | 35.6 | 35.7 | 35.0 | 34.0 |
| Rigidity (N) | 80 | 75 | 85 | 76 | 70 |
| Tensile strength (kPa) | 120 | 100 | 110 | 120 | 110 |
| Elongation (%) | 220 | 250 | 230 | 250 | 240 |
| Water absorption period (s) | 1 or | 9.2 | 10.5 | 19.5 | 15.4 |
| | less | | | | |
| Water absorption ratio (ratio) | 19.2 | 17.8 | 18.6 | 18.7 | 17.8 |
| Color difference (ΔYI) | 2 | 4 | 2 | 5 | 3 |

TABLE 2

| | Ex. 6 | Ex. 7 | Ex. 8 | Ex. 9 | Ex. 10 | Ex. 11 |
|---|---|---|---|---|---|---|
| N2200 | 100 | 100 | 100 | 100 | 100 | 100 |
| PEG600 | — | — | — | — | 3.0 | 3.0 |
| GP600 | 3.0 | — | — | — | — | — |
| Glycerol | — | 3.0 | — | — | — | — |
| Isopropanol | — | — | 3.0 | — | — | — |
| Ethylene glycol | — | — | — | 3.0 | — | — |
| Water | 2.6 | 2.6 | 2.6 | 2.6 | 2.6 | 2.6 |
| Foam stabilizer | 1.5 | 1.5 | 1.5 | 1.5 | 1.5 | 4.5 |
| Catalyst 1 | 1.0 | 1.0 | 1.0 | 1.0 | — | 1.0 |
| Catalyst 2 | — | — | — | — | 0.7 | — |
| IPDI | 56.9 | 67.2 | 61.6 | 67.0 | 56.9 | 56.9 |
| Isocyanate index | 110 | 110 | 110 | 110 | 110 | 110 |
| Density (kg/m³) | 34.9 | 34.9 | 35.6 | 35.4 | 34.4 | 34.5 |
| Rigidity (N) | 80 | 90 | 80 | 75 | 70 | 75 |
| Tensile strength (kPa) | 90 | 130 | 120 | 110 | 100 | 120 |
| Elongation (%) | 250 | 260 | 270 | 250 | 240 | 250 |
| Water absorption period | 12.0 | 18.4 | 19.8 | 18.7 | 1 or | 1 or |
| (s) | | | | | less | less |
| Water absorption ratio | 17.5 | 18.7 | 17.8 | 16.9 | 19.5 | 18.8 |
| (ratio) | | | | | | |
| Color difference (ΔYI) | 4 | 3 | 2 | 4 | 2 | 3 |

From the results shown in Tables 1 and 2, it is seen that the polyurethane foams of Examples 1 to 11 had water absorption periods of 20 seconds or less and water absorption ratios of 16 to 20, and hence exhibited excellent water absorbency. This is believed to be because the polyester polyol (N2200) was used as a polyol, and PEG600, GE1000, PEG200, or GP600 was used as a water-absorbency-imparting agent. In addition, all of the polyurethane foams of Examples 1 to 11 had ΔYI of 5 or less, and hence exhibited excellent resistance to yellowing. This is believed to be because the alicyclic polyisocyanate, IPDI, was used as a polyisocyanate.

TABLE 3

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| N2200 | 100 | 100 | 100 | 100 | 100 | — |
| GP3050F | — | — | — | — | — | 100 |
| PEG600 | — | 10.0 | — | 3.0 | — | 3.0 |
| PEG1540 | — | — | 3.0 | — | — | — |
| Water | 2.6 | 2.6 | 2.6 | 1.3 | 1.3 | 4.0 |
| Foam stabilizer | 1.5 | 1.5 | 1.5 | 1.5 | 1.5 | 1.0 |
| Catalyst 1 | 1.0 | 1.0 | 1.0 | — | — | — |
| Catalyst 3 | — | — | — | 1.0 | 1.0 | 1.0 |
| Catalyst 4 | — | — | — | — | — | 2.0 |
| IPDI | 55.8 | 59.7 | 56.2 | — | — | 74.8 |
| T-65 | — | — | — | 23.6 | 23.5 | — |
| Isocyanate index | 110 | 110 | 110 | 108 | 108 | 110 |
| Density (kg/m³) | 35.0 | Defective | Defective | 75.0 | 75.6 | 30.0 |
| Rigidity (N) | 75 | foaming | foaming | 110 | 115 | 115 |
| Tensile strength (kPa) | 100 | | | 150 | 150 | 90 |
| Elongation (%) | 220 | | | 280 | 300 | 150 |
| Water absorption period (s) | 180 or | | | 1 or | 180 or | 180 or |
| | more | | | less | more | more |
| Water absorption ratio (ratio) | 2.4 | | | 19.8 | 2.3 | 1.0 |
| Color difference (ΔYI) | 3 | | | 50 | 60 | 3 |

On the other hand, from the results shown in Table 3, it is seen that with respect to Comparative Example 1, which did not comprise, as a water-absorbency-imparting agent, a polyoxyalkylene compound with a hydroxy group at an end of the molecular chain, the water absorption period was 180 seconds or longer, and the water absorption ratio was 2.4; therefore, the water absorbency was extremely low. With respect to Comparative Example 2, which comprised a polyoxyalkylene compound in an amount exceeding 8 parts by mass per 100 parts by mass of a polyester polyol, and with respect to Comparative Example 3, which used a polyoxyalkylene compound with a molecular weight greater than 1000, defective foaming were caused due to a poor balance of the polyurethane foam raw materials.

With respect to Comparative Example 4, which used tolylene diisocyanate, which is an aromatic polyisocyanate, as a polyisocyanate, ΔYI reached 50, and the polyurethane foam suffered from a high degree of yellowing. With respect to Comparative Example 5, which used tolylene diisocyanate as a polyisocyanate, and did not comprise a polyoxyalkylene compound, ΔYI reached 60, and the polyurethane foam suffered from a very high degree of yellowing. In addition, this polyurethane foam had a water absorption period of 180 seconds or longer and a water absorption ratio of 2.3, and hence exhibited poor water absorbency. With respect to Comparative Example 6, which used the polyether polyol (GP3050F) as a polyol, hydrophilic properties were not expressed despite the addition of polyethylene glycol (PEG600), and the water absorbency was poor.

Therefore, the present examples and embodiments are to be considered as illustrative and not restrictive and the invention is not to be limited to the details given herein, but may be modified within the scope and equivalence of the appended claims.

1. A polyurethane foam with water absorbency and yellowing resistance, wherein the polyurethane foam is obtained by reacting raw materials containing a polyisocyanate, a polyol, a water-absorbency-imparting agent, a catalyst and a blowing agent to form a reaction mixture, foaming the reaction mixture to form a foamed product, and curing the foamed product,
wherein the polyol is a polyester polyol,
wherein the water-absorbency-imparting agent is a polyethylene glycol, a polyether polyol, or a polyethylene oxide adduct triol, an amount of the water-absorbency-imparting agent being from 0.5 to 8 parts by mass per 100 parts by mass of the polyester polyol,
wherein the polyisocyanate is an alicyclic polyisocyanate,
wherein the catalyst is a diazobicycloalkene or a salt thereof,
wherein an isocyanate index of a formulation of the raw materials is 80 to 120, wherein the polyurethane foam has a water absorption ratio of 16.9 to 19.5 and a color difference ΔYI of 2 to 5, the water absorption ratio being expressed by Equation (1):
water absorption ratio=(mass after water absorption−mass before water absorption)/mass before water absorption (1),
wherein the “mass after water absorption” is the mass of the polyurethane foam measured after immersing the polyurethane foam in water at ordinary temperature (25° C.) for 3 minutes, and then leaving it on a wire gauze for 1 minute, and
wherein the color difference ΔYI is expressed by Equation (2):
ΔYI=YI−YI₀ (2),
wherein YI is a value that indicates a degree of yellowing of the polyurethane foam as measured by a color difference meter after leaving the polyurethane foam for 24 hours in a desiccator charged with 50 ppm nitrogen dioxide, and then removing the polyurethane foam from the desiccator; and YI₀ is a value of YI of the polyurethane foam before being placed in the desiccator.

2. The polyurethane foam according to claim 1, wherein the time required until water dropped onto a surface of the polyurethane foam is completely absorbed into the polyurethane foam is 20 seconds or less.

3-4. (canceled)

5. The polyurethane foam according to claim 1, wherein the polyester polyol is a diethylene glycol adipate ester polyol with an average hydroxy functionality of 2 to 3.

6. The polyurethane foam according to claim 5, wherein the diethylene glycol adipate ester polyol has a number average molecular weight of 1000 to 4000.

7. The polyurethane foam according to claim 1, wherein the polyester polyol has a hydroxy value of 20 to 200 mg KOH/g.

8. The polyurethane foam according to claim 7, wherein the polyester polyol has a hydroxy value of 40 to 80 mg KOH/g.

9. (canceled)

10. The polyurethane foam according to claim 1, wherein the amount of the water-absorbency-imparting agent is 1 to 6 parts by mass per 100 parts by mass of the polyester polyol.

11. The polyurethane foam according to claim 1, wherein the isocyanate index of the formulation of the raw materials is 110.

12. (canceled)
